(19) United States
(12) Patent Application Publication
(10) Pub. No.: US 2015/0262086 A1
(43) Pub. Date: Sep. 17, 2015

(54) MANAGING PATRON SERVICING RESOURCES WITHIN A VENUE

(71) Applicants: Matthew M. MADER, Austin, TX (US); Vladimir RAHKOY, Austin, TX (US); Wayne RITTIMANN, JR., Austin, TX (US); Trevor SOSEBEE, Austin, TX (US); Ryan GOETZ, Austin, TX (US); Tom HARRISON, Austin, TX (US)

(72) Inventors: Matthew M. MADER, Austin, TX (US); Vladimir RAHKOY, Austin, TX (US); Wayne RITTIMANN, JR., Austin, TX (US); Trevor SOSEBEE, Austin, TX (US); Ryan GOETZ, Austin, TX (US); Tom HARRISON, Austin, TX (US)

(73) Assignee: VENUE VALET, LLC, Austin, TX (US)

(21) Appl. No.: 14/215,048

(22) Filed: Mar. 16, 2014

(51) Int. Cl. G06Q 10/02; G06Q 30/06

(52) U.S. Cl. CPC G06Q 10/02; G06Q 30/0613

(57) ABSTRACT

The disclosures made herein are directed to systems and methodologies that assist in the management and operations of a venue, such as a movie theater or arena. Such assistance is provided by integrating data/information from distinct systems and/or sources into a single system. Advantages of such a system include, but are not limited to, sensing the presence of patrons at designated locations within the venue (e.g., patrons, visitors and the like), determining unauthorized seating, allowing patrons to request service at the venue and provide an overall improved patron experience in the interest of improving revenue through repeat visits, and increasing patron spending during each visit to the venue.

### FIELD OF THE DISCLOSURE

The disclosures made herein relate generally to information management solutions and, more particularly, to managing patron servicing resources within a venue.

### BACKGROUND

In a venue in which patrons are served during an event (e.g., performance, showing, etc), there are several systems necessary for managing venue activities. Examples of these venue activities include, but are not limited to, food service, beverage service, ticket sales, and event logistics. To support these venue activities, a variety of information management systems are used within a venue. Examples of these systems include, but are not limited to, a system, for managing event (e.g., movie) listings (i.e., a event management system), a system for managing ticket sales (i.e. a ticket sales management system), a system for managing service personnel (i.e., a personnel management system), a system for managing service call requests from venue seating locations (i.e., a service request system) and a system for managing food and drink orders (i.e., an order management system). These systems are generally referred to herein as venue information management systems.

These venue information management systems provide very extensive functionality for their respective activities. However, a significant limitation exists in that presently there is neither single system that provides all of the functionalities of the venue information management systems nor is there a single system that integrates information captured and generated by the all of the functionalities provides by the venue information management systems. As a result, there are several discrete, yet complicated, systems used to operate many venues today that provide substantial functionality in their own way but fail to integrate with the day-to-day, real-time, systems and respective processes used by the venue to operate their business every day as well as continuously improve upon actions that result in a more satisfied patron.

Therefore, a technological solution that integrates with venue information management systems to enable management of information captured and generated by the venue information management systems for improving business operating performance and enhancing patron satisfaction would be beneficial, desirable and useful.

### SUMMARY OF THE DISCLOSURE

Embodiments of the present invention are generally directed to integrated use of information generated in association with servicing patrons within a venue. In some embodiments of the present invention, the information is generated by venue information management systems. In other embodiments, an information management system comprises systems and devices that generate the information and provides for integrated use thereof. Through such integrated use of this information, embodiments of the present invention are configured to provide a detailed, real-time view of venue operating activities and provide detailed reporting of such venue operating activities. Examples of information associated with such real-time view of venue operating activities include, but are not limited to, patron (e.g., customer/visitor) seating location within a venue, patron service requests, employee assignments with respect to specific activities and/or locations within a venue, identification and tracking and of high-value patrons, identification and tracking of profitability of food and beverage sales (e.g., on a per category basis), types and quantity of food/beverages each patron is consuming, unauthorized seating occupancy, reporting of venue occupancy with respect to media royalty payments, and the like. Accordingly, integration use of information in accordance with embodiments of the present invention provide for improved business operating performance and enhanced patron satisfaction.

In one embodiment of the present invention, an apparatus comprises a venue seating assignment system, a plurality of seat occupancy sensors, and a venue information integrating system coupled to the venue seating assignment system and to each one of the seat occupancy sensors. The venue seating assignment system is configured for assigning each one of a plurality of patrons attending an event within a venue to a respective one of a plurality of seats within the venue. Each one of the each one of the seat occupancy sensors is configured for indicating if a respective one of the seats associated therewith is in an occupied state or an unoccupied state. The venue information integrating system uses information received from the seat occupancy sensors in combination with the information received from the venue seating assignment system for determining a state of assignment of each one of the seats and for determining a state of occupancy of each one of the seats.

In another embodiment of the present invention, a method of limiting unauthorized attendance of an event within a venue comprises a plurality of operations. An operation is performed for receiving information indicating each one of a plurality of seats within a venue that has been assigned to a respective patron admittance credential and an operation is performed for monitoring a current occupancy state of the seats during an event within the venue. Thereafter, an image is performed for issuing a notification of unauthorized occupancy of a particular one of the seats in response to determining that the particular one of the seats is occupied and that the particular one of the seats is not assigned to any patron admittance credential.

In another embodiment of the present invention, a method of managing service of patrons attending an event within a venue comprises a plurality of operations. An operation is performed for receiving information indicating a seat within a venue that has been assigned to a patron admittance credential. In response to determining that the seat has been assigned to the patron admittance credential, an operation is performed for transitioning an icon representing the seat within a venue on a visual display from a state of display indicating that the seat is unoccupied and unassigned to a state of display indicating that the seat is assigned. In response to determining that the seat has become occupied after being assigned to the patron admittance credential, an operation is performed for transitioning the icon representing the seat from the state of display indicating that the seat is assigned to a state of display indicating that seat is assigned and occupied. In response to determining that the seat is occupied and that the seat is not assigned to any patron admittance credential, an operation is performed for transitioning an icon representing the seat from the state of display indicating that the seat is unoccupied and unassigned to a state of display indicating that to indicate that occupancy of the seat is unauthorized.

In another embodiment of the present invention, a method of managing service of patrons attending an event within a venue comprises a plurality of operations. An operation is performed for receiving information indicating a seat within a venue that has been assigned to a patron attending an event within the venue and an operation is performed for receiving seat occupancy information for the seat from a seat occupancy sensor thereof. The seat occupancy information indicates a current occupancy state of the seat. Thereafter, an operation is performed causing patron servicing resources to be assigned to the seat in response to determining that the seat has been assigned to a patron and has been occupied since being assigned to the patron.

Accordingly, in view of the disclosures made herein, a skilled person will appreciate that an information management apparatus configured in accordance with an embodiment of the present invention is configured to address a variety of situations with respect to venue operational activities. One such situation is related to where patrons are sitting within a venue at a particular point in time. Another such situation is related to which patrons require service. Another such situation is related to which employees are currently assigned to specific areas of the venue and how employee performance in reference to revenue and patron satisfaction is assessed. Another such situation is related to which patrons in the venue at a particular point in time are considered to be most valuable patrons and where are they sitting. Another such situation is related to which types of events at the venue result in the most profitable food sales. Still another such situation is related to which patrons in the venue are currently consuming a particular type and/or quantity of beverage (e.g., alcoholic beverages).

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a block diagram view showing an information management apparatus configured in accordance with an embodiment of the present invention.

FIG. 2 is a flow diagram view showing a method for managing seat occupancy in accordance with an embodiment of the present invention

FIGS. 3A and 3B are flow diagram views showing a method for managing patron servicing resources for an event in a venue in accordance with an embodiment of the present invention.

FIG. 4 is a flow diagram view showing a method for providing service to a plurality of associated seats in accordance with an embodiment of the present invention.

FIG. 5 is a flow diagram view showing a method for enabling status of a patron to be accounted for in managing patron servicing resources in accordance with an embodiment of the present invention.

FIG. 6 is a diagrammatic view showing a user interface dashboard configured in accordance with an embodiment of the present invention is shown.

### DETAILED DESCRIPTION

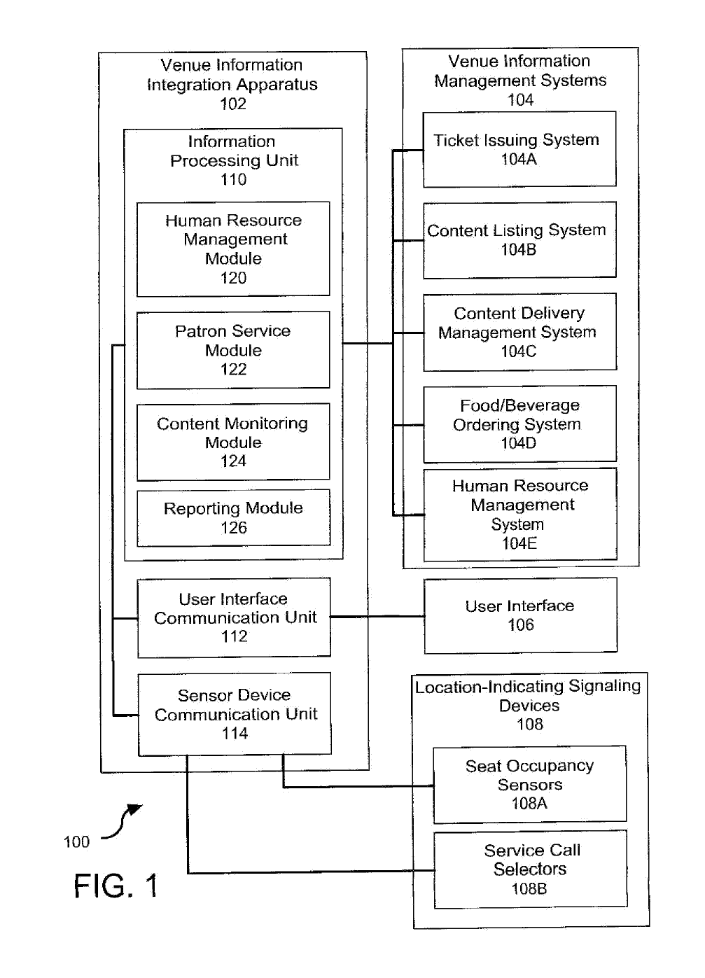

FIG. 1 shows an embodiment of information management apparatus 100 configured in accordance with an embodiment of the present invention. The information management apparatus 100 is configured for providing integrated use of information generated in association with servicing patrons within a venue. Advantageously, through such integrated use of information, the information management apparatus 100 provides a detailed, real-time view of venue operating activities and provide detailed reporting of such venue operating activities.

The information management apparatus 100 includes a venue information integration system 102, a plurality of venue information management systems 104, one or more user interface systems 106, and a plurality of location-indicating signaling devices 108. The venue information management systems 104 are coupled to an information processing unit 110 of the venue information integration system 102. The one or more user interface systems 106 are coupled to a user interface communication unit 112 of the venue information integration system 102. The location-indicating signaling devices 108 are coupled to a signaling device communication unit 114 of the venue information integration system 102. The user interface communication unit 112 and the signaling device communication unit 114 are coupled to the information processing unit 110 for enabling communication of information therebetween. It is disclosed herein that, in some embodiments of the present invention, the venue information integration system 102, the venue information management systems 104, and the seat-specific signaling devices 108 are all elements of a venue management platform in which all elements thereof are in the form of an integrated system solution (e.g., a standalone system commercially available from a single entity, a system of interoperable modules that are commercially available from a single entity, etc). It is also disclosed herein that, in some embodiments of the present invention, the venue information integration system 102 is a standalone system that receives and utilizes information from a plurality of standalone venue information management systems and from one or more types of seat-specific signaling devices. In still other embodiments, the venue information integration system 102 comprises all or a portion of the seat-specific signaling devices 108 and can optionally provide some of the functionality provided by one or more of the venue information management systems 104.

Examples of the venue information management systems 104 include, but are not limited to a ticket (i.e., admittance credential) issuing system 104A, a content listing system 104B, a content delivery management system 104C, a food/beverage ordering system 104D, a human resource management (e.g., payroll) system 104E. Examples of functionality that can be provided by the ticket issuing system 104A include, but are not limited to, selling tickets to patrons for a particular event being hosted within a venue, associating a ticket for the particular event being hosted within the venue with a particular seat within the venue, and the like. The commercially-available product offered by Vista Corporation under the product name ‘Vista Box Office’ and the commercially-available product offered by Vista Corporation under the product name ‘Vista Concessions’ are each an example of such a ticket issuing system. Examples of functionality that can be provided by the content listing system 104B include, but are not limited to, maintaining a listing of event content offered to patrons, maintaining a listing of times for such delivery of content, and outputting such listings for display/upon retrieval request, and the like. Examples of functionality that can be provided by the content delivery management system 104C include, but are not limited to, determining phase of an event that is underway, determining a completed portion of a current phase of an event, determining an uncompleted portion of a current phase of an event, determining a total length of each phase of an event, and the like. Examples of functionality that can be provided by the food/beverage ordering system 104D include, but are not limited to, a listing of line items available for ordering, managing food/beverage orders of patrons, managing of receipts and checks for food/beverage orders by patrons, managing assignment of serving resources to patrons/seating locations, and the like. The commercially-available product offered by NCR Corporation under the product Aloha, the commercially-available product offered by Vista under the product name ‘Vista Food and Beverage’, and the commercially-available product offered by Vista Corporation under the product name ‘Vista Concessions’ are each an example of such a food/beverage ordering system. Examples of functionality that can be provided by the human resource management system 104E include, but are not limited to, managing payroll activities of employees of the venue, monitoring activities of on-duty employees of the venue, managing work schedules for employees of the venue, and the like. It is disclosed herein that embodiments of the present invention are not limited to any particular collection of the venue information management systems or associated functionalities provided by such systems. For example, embodiments of the present invention can include other venue information management systems or associated functionalities not discussed above or can include less than all of the venue information management systems and associated functionalities discussed above.

The one or more user interface system 106 are each be configured for communicating with the venue information integration system 102 through the user interface communication module 112 (e.g., a wired or wireless local interface, an internet-based connection, or the like) for providing information thereto and for receiving information therefrom. Examples of the one or more user interface system 106 include, but are not limited to, laptop and desktop computer systems, smartphones, tablets, and the like. It is disclosed herein that embodiments of the present invention are not limited to any particular type or configuration of user interface system.

Examples of the location-indicating signaling devices 108 include, but are not limited to seat occupancy sensors 108A and service call selectors 108B. In preferred embodiments, the seat occupancy sensors 108A and the service call selectors 108A are each assigned and/or located on a per-seat or per-patron basis. The seat occupancy sensors 108A and service call selectors 108B are coupled to the venue information integration system 102 through the signaling device communication unit 114 (e.g., a wired or digital wireless interface). The seat occupancy sensors 108A enable occupancy of a respective seat to be determined using a signal provided by a respective one of the seat occupancy sensors. To this end, each one of the seat occupancy sensors 108A outputs a signal that indicated is a respective seat is occupied or unoccupied. Examples of seat occupancy sensors include, but are not limited to, a sensor that senses an orientation of a pivoting seat bottom cushion of a particular seat, a sensor that senses application of weight on seat bottom cushion of a particular seat, a sensor that optically/visually senses presence of a person, and a location determining application of electronic device (e.g., smartphone) that has been associated with a particular seat (e.g., by using the smartphone to scan of a code on the particular seat or admittance credential assigned to the particular seat). The service call selectors 108B enable a patron to request service at their current location via a signal provided by a respective one of the service call selectors. To this end, in response to a selection action (e.g., pressing a button) via a particular service call selectors by a patron, a patron serving resource (e.g., an assigned server) is notified that the patron has requested service (e.g., a visit to the patron). Examples of service call selectors include, but are not limited to, a button mounted on or adjacent to a particular seat and a service call button application of electronic device (e.g., smartphone) that has been associated with a particular seat (e.g., by using the smartphone to scan of a code on the particular seat or admittance credential assigned to the particular seat). The commercially-available product offered by Embedded Processor Designs Incorporated under the product name ‘HexCall’ is an example of a system providing service call selector functionality through installation of electronic signaling modules at seating locations within a venue.

In a preferred implementation of the location-indicating signaling devices 108, the seat occupancy sensors 108A and service call selectors 108B of each seat are in the form of switches of a hardware device (e.g., circuit board) that, when activated, causes the hardware device to communicate wirelessly via a standard ZigBee wireless protocol to the signaling device communication module 114 (e.g., server network communication device). The signaling device communication module 114 interprets signals from the switches as being ‘open’ or ‘closed’. The switches can be of a first type that serves as the service call selectors 108A (e.g., buttons that light up when pressed) and a second type that serves as the seat occupancy sensors 108A (e.g., sensors that are placed in or under seats to detect the presence, weight, etc of a person). The signaling device communication module 114 provides instructions (e.g., via server software) that monitors incoming signals from the seat occupancy sensors 108A and service call selectors 108B for reacting in response to receiving signals provided from the seat occupancy sensors 108A and service call selectors 108B (e.g., via ZigBee wireless signals). The server software is intelligent about the signal(s) being received and is able to determine if the signal refers to a seat being transitioned from an unoccupied state to an occupied state (or vise-versa) or if the signal refers to a patron requesting service. In this regard, the seat occupancy sensors 108A and service call selectors 108B allow for detecting the presence of a person (patron) at a specific location and allow for patrons to request service at a specific location. The request for service can be canceled through an associated action that is implemented at the venue information integration system 102 (e.g., entering a food/beverage order designating the specific location of a patron having initiated a service request).

The information processing unit 110 of the venue information integration system 102 receives information from the venue information management systems 104 for enabling implementation of functionalities through use of such information. The information processing unit 110 includes a human resource management module 120, a patron services module 122, a content monitoring module 124, and a reporting module 126. The human resource management module 120, the patron services module 122, the content monitoring module 124, and the reporting module 126 each acquire respective information from the ticket issuing system 104A, the content listing system 104B, the content delivery management system 104C, the food/beverage ordering system 104D, and the human resource management system 104E. As previously disclosed, the ticket issuing system 104A can provide the functionalities of selling tickets to patrons for a particular event being hosted within a venue, associating a ticket for the particular event being hosted within the venue with a particular seat within the venue, and the like; the content listing system 104B can provide the functionalities of maintaining a listing of event content offered to patrons, maintaining a listing of times for such delivery of content, and outputting such listings for display/upon retrieval request, and the like; the content delivery management system 104C can provide the functionalities of determining phase of an event that is underway, determining a completed portion of a current phase of an event, determining an uncompleted portion of a current phase of an event, determining a total length of each phase of an event, and the like; the food/beverage ordering system 104D can provide the functionalities of listing of line items available for ordering, managing food/beverage orders of patrons, managing of receipts and checks for food/beverage orders by patrons, managing assignment of serving resources to patrons/seating locations, and the like; and the human resource management system 104E can provide functionalities of managing payroll activities of employees of the venue, monitoring activities of on-duty employees of the venue, managing work schedules for employees of the venue, and the like.

The venue information integration system 102 is configured for using information acquired from the venue information management systems 104 and the location-indicating signaling devices 108 to provide a detailed, real-time view of venue operating activities and to provide detailed reporting of such venue operating activities. Examples of information associated with such real-time view of venue operating activities include, but are not limited to, patron (e.g., customer/visitor) seating location within a venue, patron service requests, employee assignments with respect to specific activities and/or locations within a venue, identification and tracking and of high-value patrons, identification and tracking of profitability of food and beverage sales (e.g., on a per category basis), types and quantity of food/beverages each patron is consuming, unauthorized seating occupancy, reporting of venue occupancy with respect to media royalty payments, and the like.

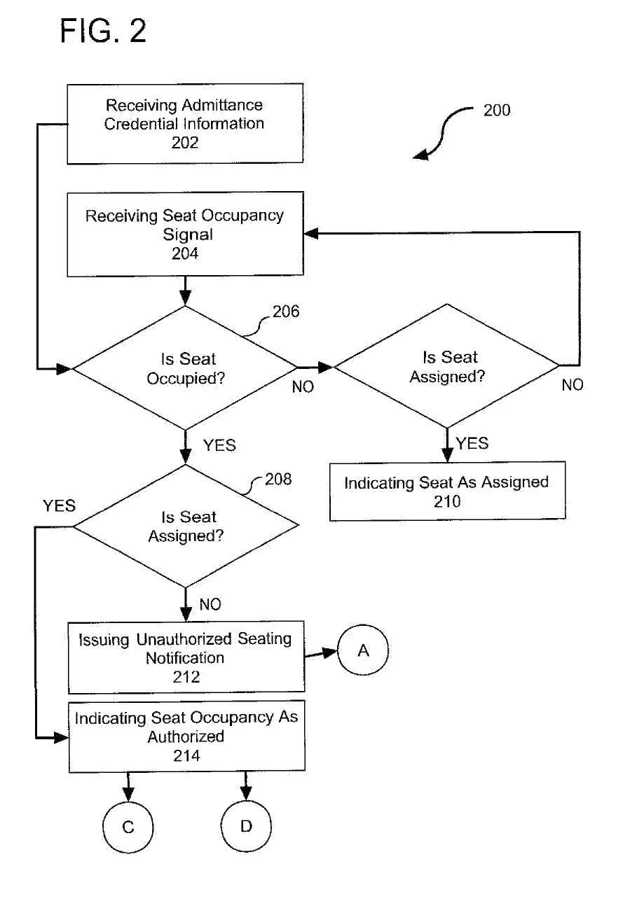

Turning now to FIG. 2, a method 200 for managing seat occupancy in accordance with an embodiment of the present invention is shown. The method 200 begins with an operation 202 being performed for receiving admittance credential information (e.g., information from a ticketing issuing system indicating that a seat has been assigned to an event ticket) and operation 204 being performed for receiving a seat occupancy signal (e.g., from a seat sensor). In response to receiving the admittance credential information and the seat occupancy signal, an operation 206 is performed for determining if the seat is occupied, followed by an operation 208 being performed for determining if the seat is occupied. If it is determining that the seat is not occupied and is not assigned, the method 200 continues at the operation 204 for receiving additional signal seat occupancy signal (e.g., is monitoring seat occupancy signals). If it is determined that the seat is assigned, but not occupied, an operation 210 is performed for indicating that the seat is assigned but not yet occupied (e.g., by sending a message, transitioning an icon on a visual display, etc) and the method 200 then continues at the operation 206 for determining if the seat becomes occupied. If it is determined that the seat is occupied (or becomes occupied) and is not assigned, an operation 212 is performed for issuing an unauthorized seating notification (e.g., by sending a message, transitioning an icon on a visual display, etc). Otherwise, if it is determined that the seat is occupied (or becomes occupied) and is assigned, an operation 214 is performed for indicating that occupancy of the seat is authorized (e.g., by sending a message, transitioning an icon on a visual display, etc). In some embodiments, an admittance credential can be configured to issue a signal (e.g., via a transponder or data processor) thereby allowing occupancy determination for a seat to be based on a specific person occupying a seat (e.g., a person in possession of the admittance credential assigned to the seat) as opposed to authorized occupancy being based solely on the seat being assigned (e.g., having an admittance credential assigned thereto).

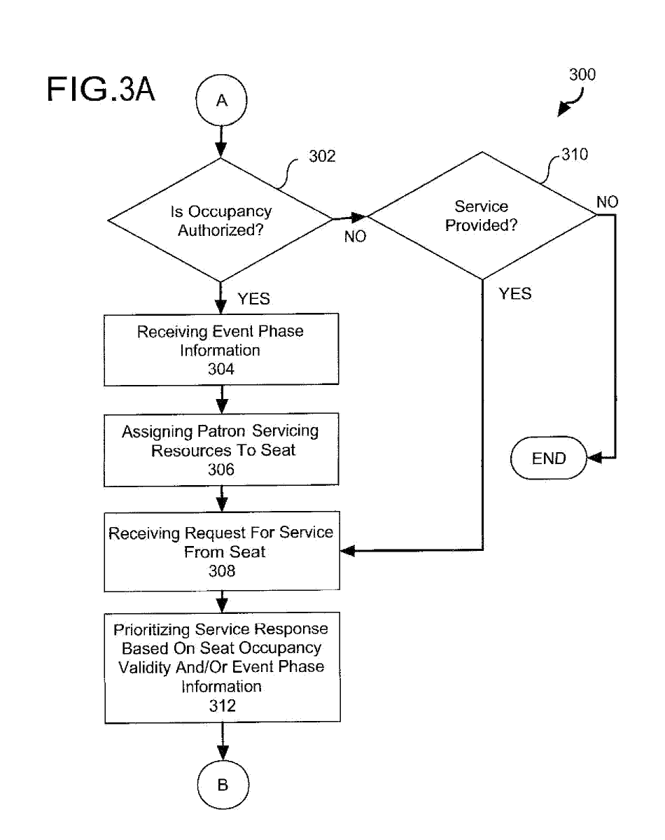

Turning now to FIGS. 3A and 3B, a method 300 for managing patron servicing resources for an event in a venue in accordance with an embodiment of the present invention is shown. The method 300 begins with an operation 302 for determining if occupancy of a seat is authorized. If it is determined that occupancy is authorized, an operation 304 is performed for determining a current phase of the event (e.g., using information received from a content delivery management system), followed by an operation 306 being performed for assigning patron servicing resources (e.g., serving personnel and seat accounts) to the seat based on the current phase of the events. In one example, patron serving personnel can be assigned at a first server-to-patron ratio during a pre-show portion of the event and at a second server-to-patron ratio after a pre-show portion of the event. In another example, a first type of patron serving personnel can be assigned to seats during a pre-show and a second type of patron serving personnel can be assigned to seats after the pre-show.

After assigning the patron servicing resources, an operation 308 is performed for receiving a request for service from the seat (e.g., a service call selector thereof). Returning now to the operation 302 for determining if occupancy of the seat is authorized, if it is determined that occupancy of the seat is unauthorized, an operation 310 is performed for determining if patron servicing resources are to be assigned to the seat. If it is determined that patron servicing resources are not to be assigned to the seat, the method ends. Otherwise, the method continues at the operation 308 for receiving the request for service from the seat at which time patron servicing resources would be assigned to the seat. In this manner, unauthorized seats are only provided service in response to a service request whereas seats with authorized occupancy may be provided with service even in the absence of a service request (e.g., to take an initial food/drink order). After receiving the request for service, an operation 312 is performed, if necessary, for prioritizing service response (i.e., response to the request for service) based on seat occupancy status (i.e., authorized or unauthorized), the current phase of the event. For example, highest service prioritization may be given to seats with authorized occupancy during an opening portion of the event (i.e., after the pre-show) with seats having unauthorized occupancy having low service prioritization or no service prioritization and, at a later time in the event, seats with unauthorized occupancy are given an intermediate or low authorized.

Following the optional operation of prioritizing the service response, an operation 314 is performed for indicating a request for service. In preferred embodiments, indicating the request for service includes causing an icon representing the seat on a visual display (e.g., dashboard of a user interface) to indicate the request for service in a manner that alters such request indication dependent upon a duration of time that has passed since the request for service was received. In this regard, the indication of the request for service can be controlled in a manner that accounts for prioritization of service response. In response to for indicating a request for service, an operation 315 is performed for initiating assessment of response time for service and an operation 316 is performed for determining if the request for service has been responded to (i.e., monitoring the request for service to determine duration of time since the request was received). In preferred embodiments, initiating assessment of response time for service includes starting a timer that reflects a duration of time that has passed since receiving the request for service. If, in response to determining if the request for service has been responded to, it is determined that the request for service has not been responded to, the method continues at the operation 314 for indicating the request for service. For example, depending on the duration of time that has passed since the request was received, the request for service indication can be escalated from one level to another (e.g., changing a displayed notification from one color to another). Otherwise, if the request has been responded to (i.e., an order being placed), the method continues with an operation 318 being performed for indicating that an order is pending. In preferred embodiments, indicating that the order is pending includes displaying an icon indicating an order is pending on a visual display (e.g., in association with the icon indicating the seat).

After indicating that the order is pending, an operation 320 is performed for determining if the order has been fulfilled. If it is determined that the order has not been fulfilled, the method continues at the operation 318 for indicating that the order is pending (i.e., monitoring order status). Otherwise, if it is determined that the order has been fulfilled, an operation 322 is performed for assessing response time for service and an operation 324 is performed for indicating that a bill is pending. Assessing response time for service can include displaying a service grade in a real-time manner on a visual display (e.g., the dashboard of the user interface) and can include outputting a report that provided summarized and detailed information with respect to the manner in which requests for service were responded to. Advantageously, the report can use information integrated in accordance with an embodiment of the present invention to assess service response performance on the basis of a specific server, seat occupancy authorization, phase of the event, number of requests from a particular seat, of any other information acquired by a venue information integration system configured in accordance with an embodiment of the present invention. Indicating that the bill is pending can include transitioning an order pending indicator to a configuration indicating that the patron has a bill that has yet to be closed, displaying a bill pending indicator in place of the order pending indicator, or the like.

After indicating that the bill is pending, an operation 326 is performed for determining if the bill has been paid. If it is determined that the bill has been paid, the method ends. Otherwise, if it is determined that the bill has not been paid, an operation 328s for determining if another service request has been received. If another request for service has not been received, the method continues at the operation 324 for indicating that the bill is pending (i.e., monitoring for bill payment with corresponding continued display of a bill pending icon). Otherwise, if it is determined that another service request has been received, an operation 330 is performed for determining possible order requests. In preferred embodiments, determining possible order requests can include attempting to anticipate wants/needs of a patron based on their past and/or recent order behavior. For example, if the patron has placed an order for a pizza and a certain brand of beer before the event started and then places a request for service 15 minutes after the event starts, one possible order request that the patron would make is for another serving of the certain brand of beer previously ordered. In view of the disclosures made herein, a skilled person will appreciate that embodiments of the present invention can include functionality to make this type of determination and display an indication of possible order requests thereby allowing the server to proactively respond to the request for service (e.g., bring one or more servings of the certain brand of beer previously ordered with them when they respond to the request for service) thereby reducing order fulfillment time associated with the request for service.

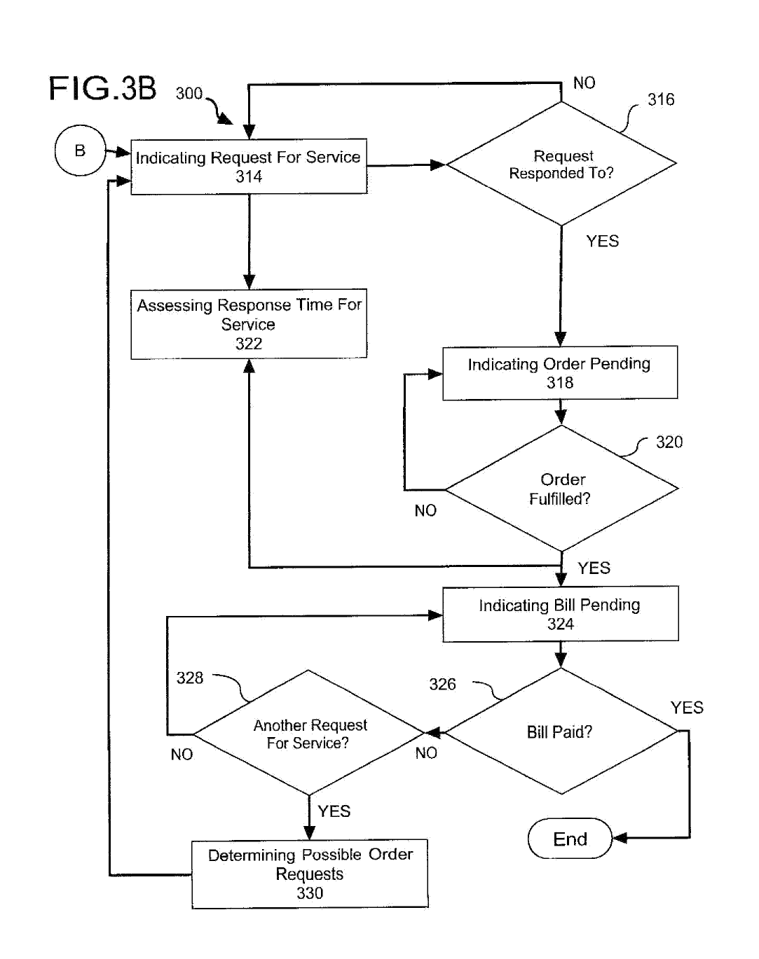

FIG. 4 shows a method 400 for providing service to a plurality of associated seats in accordance with an embodiment of the present invention. The method 400 begins with an operation 402 being performed for determining associated seats within a venue. Determining associated seats can be performed upon sale of admittance credentials (e.g., tickets) assigned to the seats and involve determining seats that are immediately adjacent to each other (e.g., a collection of seats all next to each other in a row of seats) that were all paid for with a common credit card. Thereafter, an operation 404 is performed for determining if a request to associate the seats with each other has been requested. In one example, the request for associating the seats can be made at the time of the admittance credentials assigned to the seats. In another example, the request for associating the seats can be made when a patron server is at one of the seats to provide service. If a request for associating the seats is not received, the method 400 can continue at the method 300 for managing patron servicing resources. Otherwise, if a request for associating the seats is received, an operation 406 is performed for associating a seat of a primary patron (e.g., the seat of the patron that paid for the admittance credentials assigned to all of the seats requested to be associated) with one or more other seats (e.g., the other seats that have been requested to be associated), followed by an operation 408 for causing patron servicing resources to be assigned to the associated seats as a single patron and thereafter the method 400 can continue at the method 300 for managing patron servicing resources.

In preferred embodiments, causing patron servicing resources to be assigned to the associated seats as a single patron can include associating the patron servicing resources assigned to the seat of the primary patron (i.e., a particular one of the associated seats) with the one or more other seats. In this regard, a patron service account assigned to the seat of the primary patron is assigned to all of the associated seats. In preferred embodiments, causing patron servicing resources to be assigned to the associated seats as a single patron can include visually associating all icons representing each one of the seats of the single patron on a seating chart provided on a visual display. In preferred embodiments, causing patron servicing resources to be assigned to the associated seats as a single patron can include receiving an initial request for service from a first one of the seats of the single patron, creating a service request notification for the single patron in response to receiving the initial request for service, and ignoring a subsequent request for service received from a second one of the seats of the single patron after receiving the initial request for service from the first one of the seats of the single patron or escalating a status of the service request notification in response to receiving the subsequent request for service from the second one of the seats of the single patron.

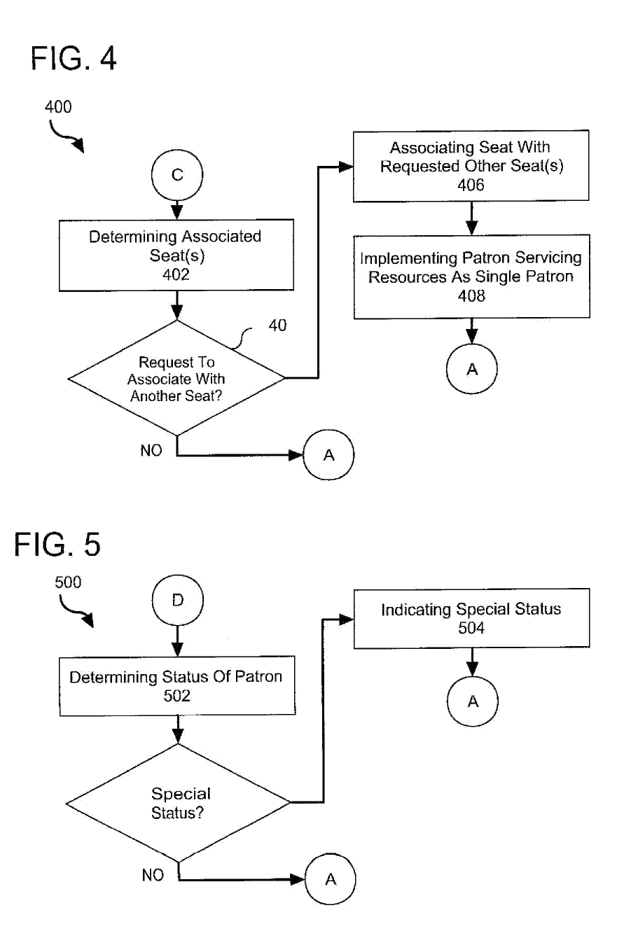

FIG. 5 shows a method 500 for enabling status of a patron to be accounted for in managing patron servicing resources in accordance with an embodiment of the present invention. The method 500 begins with an operation 502 being performed for determining a status of a patron (e.g., very important person (VIP), handicapped, certain food requirements, etc). For example, a credit card used to purchase an admittance credential to an event can be used to assess status of a patron. Alternatively, a patron can have a unique code that they use to associate themselves with an admittance credential that they have purchased (e.g., through use of a smartphone application and scanning a code on the admittance credential with their smartphone). If the patron does not have a special status, the method 500 can continue at the method 300 for managing patron servicing resources. Otherwise, if the patron does have a special status, an operation 504 is performed for indicating the special status and thereafter the method 500 can continue at the method 300 for managing patron servicing resources. Displaying an icon depicting such special status on a seating chart on a visual display is an example of for indicating the special status. In this manner, service resources and/or service response can be implemented for the patron in accordance with their special status.

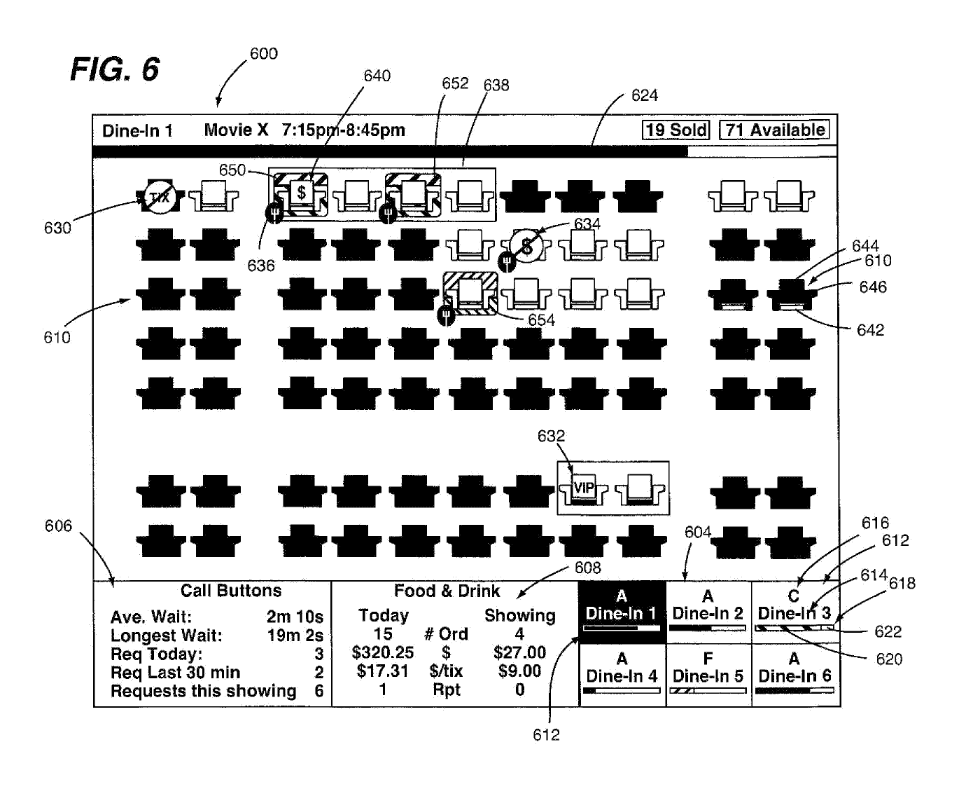

Turning now to FIG. 6, a user interface dashboard 600 configured in accordance with an embodiment of the present invention is shown. The dashboard 600 is an example of a user interface element of a venue information integration system configured in accordance with an embodiment of the present invention (e.g., the patron service module 122 of the venue information integration system discussed above in reference to FIG. 1). In preferred embodiments, the user interface dashboard is displayed on the visual display of a user interface system such as a smartphone, tablet, laptop, and/or desktop computer. Furthermore, the dashboard 600 is an example of a user interface element through which information generated by the methods 200-500 discussed above can be communicated to a user of a venue information integration system configured in accordance with an embodiment of the present invention.

The user interface dashboard 600 includes a seating chart section 602, an event area selection section 604, a service response summary section 606, and a patron order summary section 608. The seating chart section 602 includes a plurality of seat icons 610 in respective locations corresponding to actual seat locations of an event area of a venue (e.g., theater, auditorium, etc of a venue). The event area selection section 604 includes a plurality of venue area selections 612. When a particular one of the venue area selections 612 is currently selected (e.g., as indicated by the dark background for ‘Dine-In 1’, the seating chart section 602, the service response summary section 606, and the patron order summary section 608 display real-time information for the a particular one of the venue area selections 612 that is currently selected. In this regard, a user can monitor (e.g., preferably, in a real-time manner) operational activity information of the selected one of the venue area selections 612 provided by a venue information integration system configured in accordance with an embodiment of the present invention.

The service response summary section 606 shows information characterizing an assessment of response to requests for service for seats of the selected one of the venue area selections 612. The patron order summary section 608 shows information characterizing an assessment of food and beverage orders (i.e., patron orders) for seats of the selected one of the venue area selections 612. It is disclosed herein that embodiments of the present invention are not limited to any particular service response summary information or patron order summary information.

Each one of the venue area selections 612 includes a venue area identifier 614, a service response grade 616, and an event phase indicator 618. The venue area identifier 614 corresponds to a particular one of the actual areas of a venue in which content is delivered to patrons (e.g., a particular theater of a movie theater venue). The service response grade 616 characterizes a level of service provided in response to service requests for the patrons during an instance of content delivery within the particular one of the actual areas of the venue (e.g., service provided to patrons attending a movie within a particular theater of the movie theater venue. The event phase indicator 618 includes a first portion 620 for indication a portion of a phase of the event that is completed and a second portion 622 for indication a portion of the phase of the event that is yet to be completed. The event phase indicator 618 can be presented in different configurations (e.g., color and/or fill pattern) for indicating a particular phase of the event that is being depicted (E.g., corresponding to the current phase of the event that is being delivered within the venue area for the selected one of the venue area selections 612). As can be seen, the seating chart section 602 can also include a event phase indicator 624 that conveys the same information as the event phase indicator 618 of the selected one of the venue area selections 612.

Each icon 610 of the seating chart section 602 can be displayed for indicating various information with respect to a respective seat associated therewith. An unauthorized seat occupancy indicator 630 can be displayed in conjunction with an icon of a seat for which unauthorized occupancy has been determined. A patron status indicator 632 can be displayed in conjunction with an icon of a seat for which a particular status of a patron assigned to a seat has been determined. An unsecured payment indicator 634 can be displayed in conjunction with an icon of a seat for which it has been determined that payment for service has not been received (e.g., credit card information has not been received). An order pending indicator 636 can be displayed in conjunction with an icon of a seat for which it has been determined that a service order (e.g., food and/or beverage) is pending. It is disclosed herein that, in response to the service order being fulfilled, the order pending indicator 636 can transition to a configuration (e.g., different color and/or shape) indicating that the customer has a bill that has yet to be closed (e.g., credit card transaction completed). Alternatively, in response to the service order being fulfilled, a bill pending indicator (not shown) can be displayed in place of the order pending indicator 636 to indicate that the patron at the seat in question has a bill that has yet to be closed. The purpose of transitioning the order pending indicator 636 to the configuration indicating that the customer has a bill that has yet to be closed or displaying the bill pending indicator in place of the order pending indicator 636 is to show which patrons still have outstanding bills to be closed before the event they are attending ends.

As disclosed above, embodiments of the present invention can causing patron servicing resources to be assigned to a plurality of associated seats thereby allowing the seats to be serviced (e.g., requests for service responded to and billing of services) as a single patron. As shown, a plurality of the icons 610 of the user interface dashboard 600 can be indicated as being associated through an indicator 638 (e.g., a box around the associated seats). It is disclosed herein that embodiments of the present invention are not limited to a particular manner in which such association is depicted (e.g., such association could be depicted through icon color and displaying a code assigning to each of the associate seats being displayed in conjunction with the icon of each one of the associated seats). A primary seat of the associated seats can be indicated using a primary seat indicator 640 (e.g., indicating the seat from which a means for payment for service has been received).

The icon for each seat can be transitioned between a plurality of display states for indicating if the seat has been assigned (e.g., to an admittance credential) and if the seat is occupied. For example, if an entire portion of a particular one of the seat icons 610 (e.g., seat bottom cushion, seat back cushion and arm rests) is in a first display state (e.g., a first color), this indicated that the seat corresponding to the particular one of the seat icons 610 is unassigned and unoccupied. When a first portion of the particular one of the seat icons 610 (e.g., the seat bottom 642 is transitioned from the first display state to a second display state (e.g., a second color), this indicates that the seat corresponding to the particular one of the seat icons 630 is assigned but not currently unoccupied. When an entire portion of the particular one of the seat icons 610 (e.g., the seat bottom 642, seat back cushion 644, and arm rests 646) is transitioned from the first display state to the second display state, this indicates that the seat corresponding to the particular one of the seat icons 610 is assigned and occupied.

As disclosed above in reference to the method 300 for managing patron servicing resources for an event in a venue, each one of the seat icons 610 can be displayed in a manner to indicate a request for service in a manner that alters such request indication dependent upon a duration of time that has passed since the request for service was received. For example, as indicated in FIG. 6, a first service duration indicator 650 (e.g., a first color or pattern) indicates that a pending service response is in a first duration of time since a request for service was received, a second duration indicator 652 (e.g., a second color or pattern) indicates that a pending service response is in a second duration of time since the request for service was received, and a third duration indicator 652 (e.g., a third color or pattern) indicates that a pending service response is in a third duration of time since the request for service was received. In this manner, an indication for response to a request for service can be escalated and associated reporting (e.g., venue service response grading) can be performed in dependent upon such response time information. Selection of a particular seat icon can cause a timer to be displayed that indicated a total duration of time that a request for service has been pending.

In view of the disclosures made herein, a skilled person will appreciate that an information management apparatus configured in accordance with an embodiment of the present invention integrates (e.g., consolidates) information from multiple systems for enabling unique functionality with respect to generating and presenting information associated with venue operational activities. In addition to generation and presentation of real-time integration of information, trends can be determined and presented that indicate improving or degrading situations in a venue. In this regard, advantageously, an information management apparatus configured in accordance with an embodiment of the present invention integrates information for various venue operations activities, which can be based on information from existing and disparate venue information management systems, to provide contextual information and reporting.

In view of the disclosures made herein, a skilled person will appreciate that an information management apparatus configured in accordance with an embodiment of the present invention is configured to address a variety of situations with respect to venue operational activities. One such situation is related to where patrons are sitting within a venue at a particular point in time. Another such situation is related to which patrons require service. Another such situation is related to which employees are currently assigned to specific areas of the venue and how employee performance in reference to revenue and patron satisfaction is assessed. Another such situation is related to which patrons in the venue at a particular point in time are considered to be most valuable patrons and where are they sitting. Another such situation is related to which types of events at the venue result in the most profitable food sales. Still another such situation is related to which patrons in the venue are currently consuming a particular type and/or quantity of beverage (e.g., alcoholic beverages).

Examples of these unique functionality with respect to generating and presenting information associated with venue operational activities that are enabled by an information management apparatus configured in accordance with an embodiment of the present invention include, but are not limited to, the following. One such example includes accepting incoming requests from any device (e.g., a web-enabled device) to display current status of a venue on the device. Elements that summarize the current status of a venue include, but are not limited to, which movies/events are currently playing and where, which seats are sold and which are vacant, which patrons currently need service, which employees are currently assigned to certain areas of the venue, which patrons have placed food orders, which patrons have paid, or not, for their food order, which patrons have ordered alcoholic beverages, how many food orders and total amounts for an event and for an entire day. Another such example includes generating summarizations of venue data to be used for displaying the current status of a venue. There is a tremendous amount of data available in ticket issuing system and food/beverage POS systems that are used to operate venues. This information is integrated and presented in a real-time manner. Another such example includes communicating with remote/external systems (e.g., data repositories) on a regular interval to pull relevant data together in one location for displaying the current status of a venue as well as to generate real-time and historical reports. Common data repositories include, but are not limited to ticket sales, food/beverage sales, venue event listings and start/end times, employee scheduling records and patron loyalty information. Another such example includes allowing venue management to assign employees to specific areas within the venue to allow for real-time and historical reporting of employee performance in relation to sales, service times, etc. Another such example includes providing contextual information, both real-time and historical, about ticket sales, event details, food/beverage sales, patron location (seat sensors), patron service requests (call button), employees and patron details to allow for more effective management of a venue, the venue patrons and overall experience within and productivity of the venue by delivering information to venue employees through any web-enabled device (screen) in such a way that the information can be acted upon. Common actions include adjusting where employee resources are currently assigned within the venue to address patron activities/requests, approaching a patron location to provide service and notifying employees of a “VIP” patron that is eligible to receive a special offer or opportunity within the venue. Another such example includes being aware of future events and all related contextual information for that event at a venue to allow registered patrons to be presented with the opportunity to purchase tickets for future events, where future may be only minutes in the future, with the desired effect being increased revenue for the venue and an ideal, economical and convenient experience for the patron. The opportunity can be presented to a patron via an email, text message or a smart phone mobile application and the opportunity can be accepted or rejected by the patron as well as validated and tracked by the venue. For example, if the current time is 4 PM and there is a showing/event at 7 PM that has open/available seats (or a pre-determined % of open seats such as less than 50% occupied), which is determined via the integration with the ticketing system, a number of communications (email, text, mobile app alert, etc.) can be used to broadcast an opportunity to the patron. Another such example includes being able to judge/grade the real-time status of a venue, or locations within a venue, to allow pro-active actions to be taken by management to address situations currently happening within the venue. For example, the grade of a theater can be determined by combining a number of variables together with weights assigned to them. Variables can include the % of tickets sold for an event (occupancy rate), number of patrons requesting service, number of employees assigned to service a specific area of the venue and the time patrons are waiting to get their request for service acknowledged.

It is disclosed herein that an information management apparatus configured in accordance with an embodiment of the present invention can be implementing using any number of computer system platforms and architectures. In this regard, an information management apparatus configured in accordance with an embodiment of the present invention is not limited to being implemented in any particular computer system platform and architecture. For example, a venue information integration system configured in accordance with an embodiment of the present invention can be implemented as a server that communicates with other systems and devices (i.e., clients). Similarly, an venue information management apparatus configured in accordance with an embodiment of the present invention can be implemented as a standalone system (e.g., comprising all system elements) and that enables client devices to access information generated by the venue information management system.

Turning now to a discussion of approaches for implementing embodiments of the present invention, systems and methods in accordance with embodiments of the present invention can be implemented in any number of different types of computer systems (i.e., a data processing systems) in addition to the specific physical implementation of a data processing system. Such a computer system can provide functionality as a result of logic hardwired or otherwise embodied in a circuit, which can operate in place of or together with software to execute one or more processes or one or more steps of one or more processes or methods described or illustrated herein. Reference to software in this disclosure can encompass logic, and reference to logic can encompass software. Moreover, reference to a computer-readable medium (also sometimes referred to as machine-readable medium” can encompass a circuit (such as an integrated circuit) storing software for execution, a circuit embodying logic for execution, or both, where appropriate. The present disclosure encompasses any suitable combination of hardware, software, or both.

The term “computer-readable medium” should be understood to include any structure that participates in providing data that can be read by an element of a computer system. Such a medium can take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium. The computer-readable medium has tangibly embodied thereon and accessible therefrom processor-executable instructions that, when executed by at least one data processing device of at least one computer, causes said at least one data processing device to perform a method comprising a plurality of operations of one or more method disclosed herein. In some embodiments, such computer-readable medium will be in the form of a non-transitory computer readable medium.

Those of skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments a computer system disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present invention.

The various illustrative logical blocks, modules, and circuits described in connection with a computer system as disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

The previous description of the disclosed embodiments is provided to enable any person skilled in the art to make or use the present invention. Various modifications to these embodiments will be readily apparent to those skilled in the art, and the generic principles defined herein can be applied to other embodiments without departing from the spirit or scope of the invention. Thus, the present invention is not intended to be limited to the embodiments shown herein but is to be accorded the widest scope consistent with the principles and novel features disclosed herein.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A method of managing service of patrons attending an event within a venue, comprising:
receiving information indicating a seat within a venue that has been assigned to a patron attending an event within the venue;
receiving seat occupancy information for the seat from a seat occupancy sensor thereof, wherein the seat occupancy information indicates a current occupancy state of the seat; and
causing patron servicing resources to be assigned to the seat in response to determining that the seat has been assigned to a patron and has been occupied since being assigned to the patron.

2. The method of claim 1 wherein:
causing patron servicing resources to be assigned to the seat is performed after determining that the seat has been assigned to the patron admittance credential and while the seat is occupied; and
causing patron servicing resources to be assigned includes causing one or more patron servers to be associated with the seat.

3. The method of claim 2, further comprising:
receiving a signal indicating a request for service at the seat after assigning the patron servicing resources; and
causing a duration of time taken to respond to the request for service to be assessed in response to receiving the signal for indicating the request for service.

4. The method of claim 3 wherein:
in response to receiving the signal for indicating the request for service, causing an icon representing the seat to indicate the request for service in a manner that alters such request indication dependent upon a duration of time that has passed since the signal for indicating the request for service was received.

5. The method of claim 1 wherein:
in response to receiving a signal for indicating a request for service, causing an icon representing the seat to indicate the request for service in a manner that alters such request indication dependent upon a duration of time that has passed since the signal for indicating the request for service was received.

6. The method of claim 1, further comprising:
causing a duration of time taken to respond to a request for service to be assessed in response to receiving the signal for indicating the request for service; and
receiving information indicating a current phase of the event;
wherein causing the duration of time taken to respond to the request for service to be assessed is performed dependent upon the current phase of the event.

7. The method of claim 1, further comprising:
causing a status of the patron to be determined; and
after receiving the service request and determining the status of the patron, generating service request response information for enabling a server to provide service to the patron, wherein the service request response information includes displaying information indicating the status of the patron.

8. The method of claim 7 wherein:
causing the patron servicing resources to be assigned to the seat is performed after determining that the seat has been assigned to the patron admittance credential and that the seat is occupied; and
assigning the patron servicing resources includes associating one or more patron servers to the seat.

9. The method of claim 7, further comprising:
receiving a signal indicating a request for service at the seat after assigning the patron servicing resources; and
causing a duration of time taken to respond to the request for service to be assessed in response to receiving the signal for indicating the request for service.

10. The method of claim 9 wherein:
in response to receiving the signal for indicating the request for service, causing an icon representing the seat to indicate the request for service in a manner that alters such request indication dependent upon a duration of time that has passed since the signal for indicating the request for service was received.

11. The method of claim 1, further comprising:
receiving a request to associate the patron servicing resources assigned to the seat with one or more other seats whereby the seat and the one or more other seats are served as a single patron; and
associating the patron servicing resources assigned to the seat with the one or more other seats in response to receiving the request to associate the patron servicing resources.

12. The method of claim 11, further comprising:
visually associating icons representing each one of the seats of the single patron on a seating chart provided on a visual display in response to associating the patron servicing resources assigned to the seat with the one or more other seats.

13. The method of claim 11, further comprising:
receiving an initial request for service from a first one of the seats of the single patron;
creating a service request notification for the single patron in response to receiving the initial request for service; and
one of ignoring a subsequent request for service received from a second one of the seats of the single patron after receiving the initial request for service from the first one of the seats of the single patron and escalating a status of the service request notification in response to receiving the subsequent request for service from the second one of the seats of the single patron.

14. A non-transitory computer-readable medium having tangibly embodied thereon and accessible therefrom processor-executable instructions that, when executed by at least one data processing device of at least one computer, causes said at least one data processing device to perform a method comprising:
receiving information indicating a seat within a venue that has been assigned to a patron attending an event within the venue;
receiving seat occupancy information for the seat, wherein the seat occupancy information indicates a current occupancy state of the seat; and
causing patron servicing resources to be assigned to the seat in response to determining that the seat has been assigned to a patron and has been occupied since being assigned to the patron.

15. The non-transitory computer-readable medium of claim 14 wherein:
causing patron servicing resources to be assigned to the seat is performed after determining that the seat has been assigned to the patron admittance credential and while the seat is occupied; and
causing patron servicing resources to be assigned includes causing one or more patron servers to be associated with the seat.

16. The non-transitory computer-readable medium of claim 15, further comprising:
receiving a signal indicating a request for service at the seat after assigning the patron servicing resources; and
causing a duration of time taken to respond to the request for service to be assessed in response to receiving the signal for indicating the request for service;
wherein in response to receiving the signal for indicating the request for service, causing an icon representing the seat to indicate the request for service in a manner that alters such request indication dependent upon a duration of time that has passed since the signal for indicating the request for service was received.

17. The non-transitory computer-readable medium of claim 14 wherein:
in response to receiving a signal for indicating a request for service, causing an icon representing the seat to indicate the request for service in a manner that alters such request indication dependent upon a duration of time that has passed since the signal for indicating the request for service was received.

18. The non-transitory computer-readable medium of claim 14, further comprising:
causing a duration of time taken to respond to a request for service to be assessed in response to receiving the signal for indicating the request for service; and
receiving information indicating a current phase of the event;
wherein causing the duration of time taken to respond to the request for service to be assessed is performed dependent upon the current phase of the event.

19. The non-transitory computer-readable medium of claim 14, further comprising:
causing a status of the patron to be determined; and
after receiving the service request and determining the status of the patron, generating service request response information for enabling a server to provide service to the patron, wherein the service request response information includes displaying information indicating the status of the patron.

20. The non-transitory computer-readable medium of claim 19 wherein:
causing the patron servicing resources to be assigned to the seat is performed after determining that the seat has been assigned to the patron admittance credential and that the seat is occupied; and
assigning the patron servicing resources includes associating one or more patron servers to the seat.

21. The non-transitory computer-readable medium of claim 20, further comprising:
receiving a signal indicating a request for service at the seat after assigning the patron servicing resources; and
causing a duration of time taken to respond to the request for service to be assessed in response to receiving the signal for indicating the request for service.

22. The non-transitory computer-readable medium of claim 21, further comprising:
receiving a request to associate the patron servicing resources assigned to the seat with one or more other seats whereby the seat and the one or more other seats are served as a single patron; and
associating the patron servicing resources assigned to the seat with the one or more other seats in response to receiving the request to associate the patron servicing resources.

23. The non-transitory computer-readable medium of claim 22, further comprising:
visually associating all icons representing each one of the seats of the single patron on a seating chart provided on a visual display in response to associating the patron servicing resources assigned to the seat with the one or more other seats.

24. The non-transitory computer-readable medium of claim 22, further comprising:
receiving an initial request for service from a first one of the seats of the single patron;
creating a service request notification for the single patron in response to receiving the initial request for service; and
one of ignoring a subsequent request for service received from a second one of the seats of the single patron after receiving the initial request for service from the first one of the seats of the single patron and escalating a status of the service request notification in response to receiving the subsequent request for service from the second one of the seats of the single patron.
